(19) United States
(12) Patent Application Publication
(10) Pub. No.: US 2017/0276990 A1
(43) Pub. Date: Sep. 28, 2017

(54) DISPLAY DEVICE

(71) Applicant: InnoLux Corporation, Miao-Li County (TW)

(72) Inventors: Chien-Hung CHEN, Miao-Li County (TW); Yuchih TSENG, Miao-Li County (TW)

(21) Appl. No.: 15/453,933

(22) Filed: Mar. 9, 2017

(30) Foreign Application Priority Data
Mar. 22, 2016 (TW) 105108780

(51) Int. Cl. G02F 1/1339; G02F 1/1368; G02F 1/1343; G02F 1/1362

(52) U.S. Cl. CPC G02F 1/13394; G02F 1/136286; G02F 1/1368; G02F 1/13439; G02F 1/134309; G02F 2001/13398

(57) ABSTRACT

A display device is disclosed, which includes: a first substrate; a scan line disposed on the first substrate and extending along a first direction; a first thin film transistor unit electrically connecting to the scan line; a second substrate opposite to the first substrate; a spacer disposed between the first and the second substrate and partially overlapping the first thin film transistor unit; a transparent conducting electrode; and two data lines extending along a second direction different from the first direction, wherein the transparent conducting electrode is disposed on the scan line and the two data lines. The transparent conducting electrode comprises a main electrode having a longitudinal direction substantially identical to the second direction; the spacer and the main electrode respectively have a first width and a second width in the first direction, and a ratio between the first and second width ranges between 5:1 and 5:4.

### CROSS REFERENCE TO RELATED APPLICATION

This application claims the benefits of the Taiwan Patent Application Serial Number 105108780, filed on Mar. 22, 2016, the subject matter of which is incorporated herein by reference.

### BACKGROUND

1. Field of the disclosure

The present disclosure relates to display devices, and more particularly to a display device having a uniquely positioned spacer.

2. Description of Related Art

With the continuous development of technology related to displays, there is a trend in the display industry toward smaller volume, thinner and lighter products. Thus, thin displays, such as liquid crystal display devices, organic light-emitting diode display devices, and inorganic light-emitting diode display devices have substituted for CRT displays as the dominant display devices in the market. Thin displays have an extensive application scope, and we can see them in many of consumer electronics, such as mobile phones, laptops, video cameras, still cameras, music players, mobile navigators, TV sets, etc.

Therein, liquid crystal display devices have been well developed and popular among consumers. However, in view of the consumers' increasing requirements to display quality of display devices, every dealer in this industry are investing in advancing display devices particularly in terms of display quality.

In a general liquid crystal display device, the liquid crystal layer is sandwiched between two substrates and by controlling the orientation of liquid crystal molecules, different levels of brightness can be exhibited. For holding a constant distance between the two substrates, a common approach is to set a spacer. However, since such a spacer is raised from the substrates, those liquid crystal molecules near the spacer can have their orientation affected by the raised structure, and this degrades the transmittance of the display device.

In view of this, for improving display quality, there is a need for a display device that secures a display device's transmittance by preventing a spacer as a raised structure from affecting the medium of the display device.

### SUMMARY

A primary objective of the present disclosure is to provide a display device, which has a spacer well positioned therein to improve the optical performance of liquid crystal in the visual area.

The disclosed display device comprises: a first substrate; a scan line disposed on the first substrate and extending along a first direction; a first thin film transistor unit electrically connecting to the scan line; a second substrate disposed opposite to the first substrate; a display medium layer disposed between the first substrate and the second substrate; a spacer disposed between the first substrate and the second substrate and partially overlapping the first thin film transistor unit; a transparent conducting electrode; and two data lines, wherein the two data lines are extending along a second direction, the first direction is different from the second direction, and the transparent conducting electrode is disposed on the scan line and the two data lines. Herein, the transparent conducting electrode further comprises a main electrode, the main electrode has a longitudinal direction substantially identical to the second direction; wherein the spacer has a first width in the first direction, the main electrode has a second width in the first direction, and a ratio between the first width and the second width ranges between 5:1 and 5:4.

In a conventional display device, spacers are usually disposed in the non-visual area but not the visual area. Even though, since the spacer is a raised structure, its presence can nevertheless negatively affect the display medium (e.g., liquid crystal molecules) therearound in terms of optical performance and lead to dark fringes that degrade the transmittance of the display device. Hence, the disclosed display device has its spacer partially overlapping the first thin film transistor unit, thereby reducing the impact of the spacer on the display medium and in turn improving the transmittance of the display device.

Other objects, advantages, and novel features of the disclosure will become more apparent from the following detailed description when taken in conjunction with the accompanying drawings.

### BRIEF DESCRIPTION OF THE DRAWINGS

FIG. 1 is a cross-sectional view of a display device of an embodiment of the present disclosure.

FIG. 2 is a cross-sectional view of a display device of another embodiment of the present disclosure.

FIG. 3 is a top view of a display device of an embodiment of the present disclosure.

FIG. 4A through FIG. 4F show a spacer positioned differently in a display device of an embodiment of the present disclosure.

FIG. 4G is a cross-sectional view of a display device according to the line A-A′ indicated in FIG. 3.

FIG. 5 is a diagram of results of simulation with the arranagements of FIG. 4A through FIG. 4E.

FIG. 6 is a top view of a display device of another embodiment of the present disclosure.

FIG. 7 is a top view of a display device of yet another embodiment of the present disclosure.

### DETAILED DESCRIPTION OF EMBODIMENT

The following embodiments when read with the accompanying drawings are made to clearly exhibit the above-mentioned and other technical contents, features and effects of the present disclosure. Through the exposition by means of the specific embodiments, people would further understand the technical means and effects the present disclosure adopts to achieve the above-indicated objectives. Moreover, as the contents disclosed herein should be readily understood and can be implemented by a person skilled in the art, all equivalent changes or modifications which do not depart from the concept of the present disclosure should be encompassed by the appended claims.

Furthermore, the ordinals recited in the specification and the claims such as “first”, “second” and so on are intended only to describe the elements claimed and imply or represent neither that the claimed elements have any preceding ordinals, nor that sequence between one claimed element and another claimed element or between steps of a manufacturing method. The use of these ordinals is merely to differentiate one claimed element having a certain designation from another claimed element having the same designation.

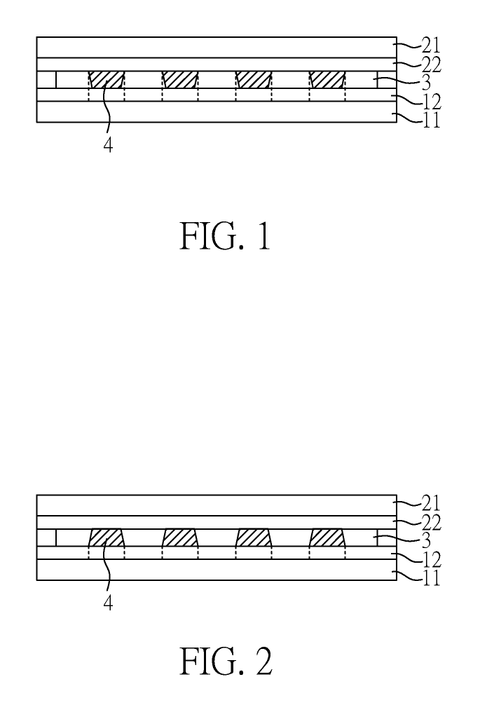

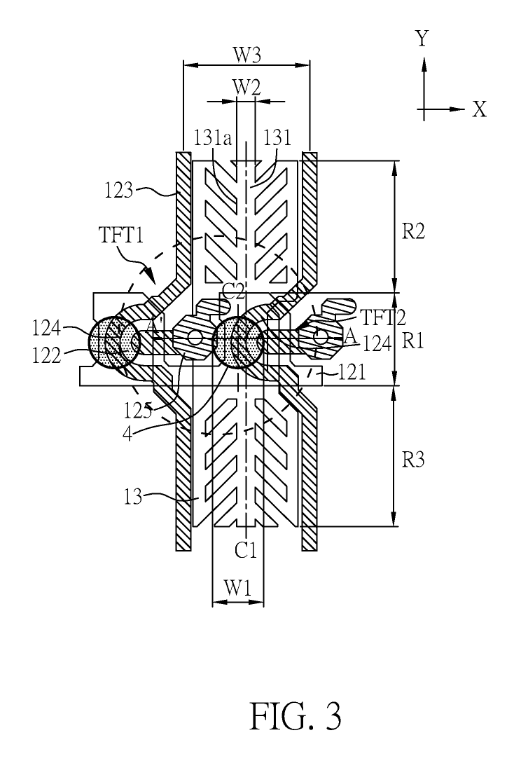

FIG. 1 and FIG. 2 are cross-sectional view of display devices according to two embodiments of the present disclosure. As shown, the display device in FIG. 1 comprises: a first substrate 11; a second substrate 21 disposed opposite to the first substrate 11; a display medium layer 3 disposed between the first substrate 11 and the second substrate 21; and a spacer 4 disposed between the first substrate 11 and the second substrate 21 for separating the first substrate 11 from the second substrate 21 by a fixed distance. In the present embodiment, the first substrate 11 and the second substrate 21 may be made of glass, plastic or a flexible material. The display medium layer 3 may be a liquid crystal layer and the spacer 4 may be made of a photoresist material.

The first substrate 11 and the second substrate 21 may be atop provided with different elements. For example, a TFT layer 12 may be deposited on the first substrate 11 so as to form a thin film transistor substrate, and a color filtering layer 22 may be deposited on the second substrate 21 so as to form a color filter substrate. However, the present disclosure is not limited thereto. The color filtering layer 22 may be alternatively attached to the first substrate 11 instead of the second substrate 21. In this case, the first substrate 11 and the elements thereon form a thin film transistor substrate having an integrated color filter array (i.e. a color filter on array, or a COA).

The difference between FIG. 1 and FIG. 2 is that in FIG. 1 the spacer 4 is first formed on the second substrate 21, and then the first substrate 11 is assembled to the second substrate 21, so the spacer 4 is in the shape of an inverted trapezoid, while in FIG. 2 the spacer 4 is first formed on the first substrate 11, so the spacer 4 is in the shape of a regular trapezoid. In other embodiments of the present disclosure, the spacer 4 may be a columnar member. However, the present disclosure is not limited thereto, provided that the spacer 4 in the resulting display device is disposed between the first substrate 11 and the second substrate 21 and separates the two by a fixed distance.

The following description will be directed to the relative relation between the elements atop the first substrate 11 and the spacer 4 in detail. In the present disclosure, the relation between the spacer 4 and the elements atop the first substrate 11 is defined on the basis of the appearance of the spacer 4 as projected onto the first substrate 11. As shown in FIG. 1 and FIG. 2, the projected profile of the spacer 4 on the first substrate 11 is indicated by the dotted lines.

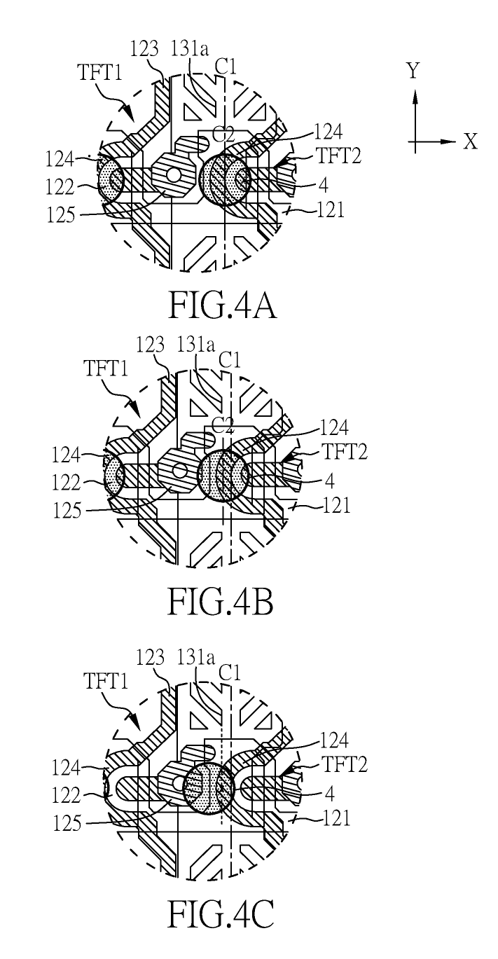

Referring to FIG. 1 and FIG. 3, a display device in an embodiment of the present disclosure comprises: a first substrate 11; a scan line 121 disposed on the first substrate 11 and extending along a first direction X; a first thin film transistor unit TFT1 electrically connecting to the scan line 121; a second substrate 21 disposed opposite to the first substrate 11; a display medium layer 3 disposed between the first substrate 11 and the second substrate 21; and a spacer 4 disposed between the first substrate 11 and the second substrate 21 and partially overlapping the first thin film transistor unit TFT1.

In addition, the display device of the present embodiment further comprises a transparent conducting electrode 13 and two data lines 123 extending along a second direction Y, wherein the first direction X and the second direction Y are different. In the present embodiment, the first direction X is vertical to the second direction Y; but the present disclosure is not limited thereto. The transparent conducting electrode 13 is disposed on the scan line 121 and two adjacent data lines 123. Here, the relative position of the scan line 121 and the transparent conducting electrode 13 is not limited. For example, the scan line 121 may be located at one side of the transparent conducting electrode 13 or at the center of the transparent conducting electrode 13. In one of the embodiments, the scan line 121 passes through a central section R1 of the transparent conducting electrode 13, as shown in FIG. 3.

Where the scan line 121 passes through the central section R1 of the transparent conducting electrode 13, the transparent conducting electrode 13 may further comprise two slit sections R2, R3, and the central section R1 is located between the two slit sections R2, R3. In this aspect of the present embodiment, the central section R1 is located at the very center of the transparent conducting electrode 13, so the two slit sections R2, R3 at two sides of the central section RI have the same area size. However, in other embodiments of the present disclosure, the central section R1 is not necessarily located at the very center of the transparent conducting electrode 13 but located at a different site on the transparent conducting electrode 13 instead, such as a trisection point or a quarter point or any other site on the transparent conducting electrode 13.

In addition, in the display device of the present embodiment, the first thin film transistor unit TFT1 partially overlaps the central section R1. The first thin film transistor unit TFT1 comprises a switch electrode. The switch electrode has an active layer 122, a first part 124 and a second part 125. The spacer 4 partially overlaps one of the first part 124 and the second part 125 of the switch electrode. In the present embodiment, the spacer 4 partially overlaps the second part 125 of the first thin film transistor unit TFT1. Herein, the first part 124 may be a source or a drain. Where the first part 124 is a source, the second part 125 is defined as a drain, and the reverse applies.

In the case where the display device of the present embodiment is one with a small pixel unit, since the pixel unit is limited in size, the spacer 4 partially overlaps the thin film transistor unit of the adjacent pixel unit, and particularly the switch electrode of the thin film transistor unit in addition to the first thin film transistor unit TFT1. Herein, the phrase “small pixel unit” refers to a pixel unit (more particularly, the center line of two adjacent data lines 123) whose pixel width W3 in the first direction X is between 10 μm and 100 μm.

More particularly, as shown in FIG. 3, the display device of the present embodiment may further comprise a second thin film transistor unit TFT2. It is electrically connecting to the scan line 121 and is adjacent to the first thin film transistor unit TFT1. The spacer 4 partially overlaps the second thin film transistor unit TFT2. In the present embodiment, the spacer 4 partially overlaps the first part 124 of the second thin film transistor unit TFT2. Herein, for the sake of clarity, the second thin film transistor unit TFT2 in FIG. 3 is partially omitted and only has the first part 124 shown.

Moreover, as shown in FIG. 3, the transparent conducting electrode 13 further comprises a main electrode 131. The main electrode 131 has its longitudinal direction substantially identical to the second direction Y. Therein, the spacer 4 has a first width W1 in the first direction X, and the main electrode 131 has a second width W2 in the first direction X. A ratio between the first width W1 and the second width W2 is between 5:1 and 5:4, Furthermore, two adjacent data lines 123 have a pixel width W3 in the first direction X, and a ratio between the first width W1 and the pixel width W3 is greater than 0 and smaller than 1/4, or greater than 0 and smaller than or equal to 0.35.

As described previously, even if the spacer 4 of the present embodiment has a raised structure that may affect the optical performance of the display medium therearound (e.g., liquid crystal molecules) and degrade the display device's transmittance, with the fact that the spacer 4 is designed to partially overlap the first thin film transistor unit TFT1, the impact of the spacer 4 on the display medium is reduced, thereby improving the display device's transmittance.

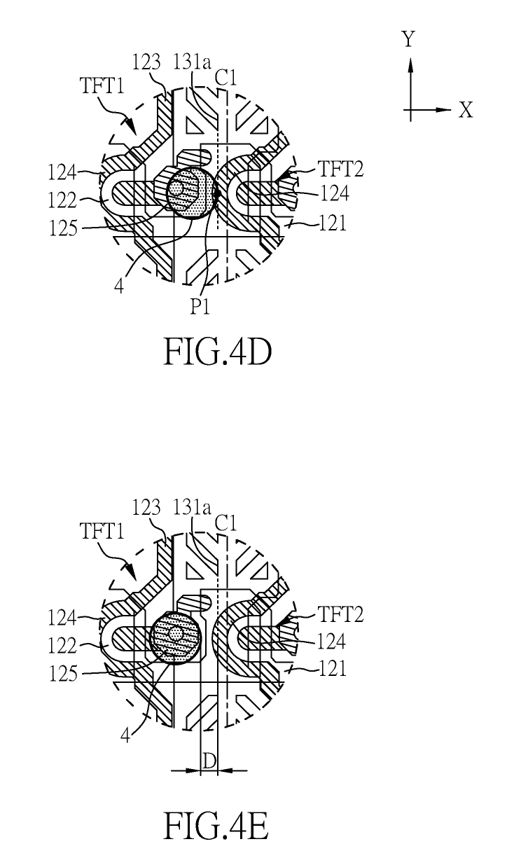

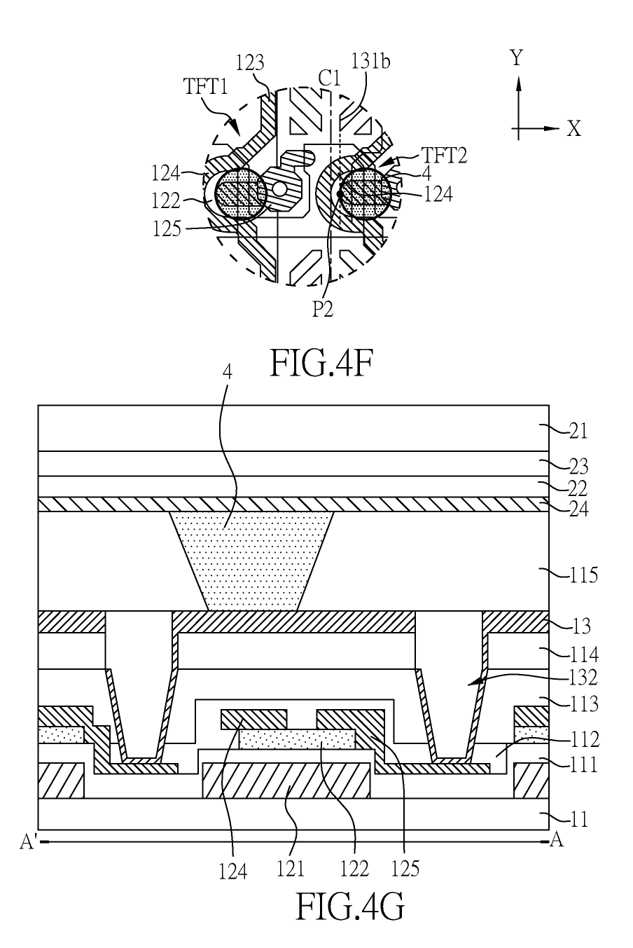

FIG. 4A through FIG. 4E show a spacer positioned differently in a display device of a preferred embodiment of the present disclosure, wherein only the part circled in FIG. 3 by the dotted line is shown. Referring to FIG. 3 and FIG. 4A, the main electrode 131 of the transparent conducting electrode 13 has an electrode center line C1, and an extension direction of the electrode center line C1 is substantially identical to the second direction Y. The spacer 4 also has a spacer center line C2, and an extension direction of the spacer center line C2 is substantially identical to the second direction Y. Therein, the electrode center line C1 of the main electrode 131 coincides with the spacer center line C2 of the spacer 4. As shown in FIG. 3 and FIG. 4B, the main electrode 131 of the transparent conducting electrode 13 has a lateral side 131a. The lateral side 131a is adjacent to the first thin film transistor unit TFT1 and has its longitudinal direction substantially identical to the second direction Y. Therein, an extension line of the lateral side 131a of the main electrode 131 coincides with the spacer center line C2 of the spacer 4. As shown in FIG. 3 and FIG. 4C, the extension line of the lateral side 131a of the main electrode 131 coincides with the spacer 4 at a quarter point of its diameter. As shown in FIG. 3 and FIG. 4D, the spacer 4 has an end point P. The end point P is a point farthest from the first thin film transistor unit TFT1. Therein, the extension line of the lateral side 131a of the main electrode 131 coincides with the end point P of the spacer 4. As shown in FIG. 3 and FIG. 4E, the extension line of the lateral side 131a of the main electrode 131 and the end point P of the spacer 4 are separated by a distance D.

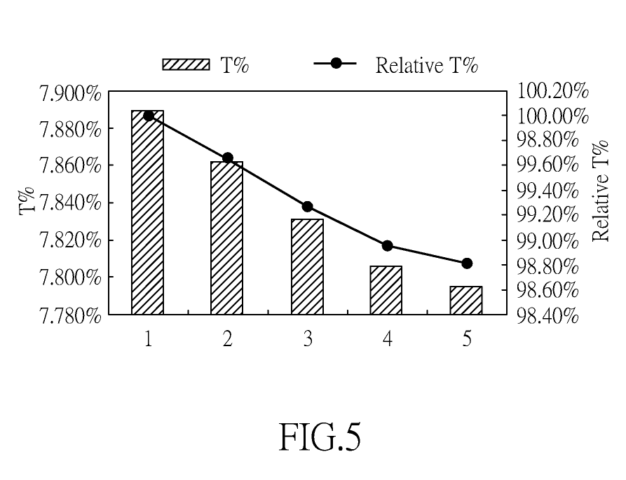

As shown in FIG. 3, herein, it is assumed that in a single pixel unit, the pixel width W3 is 39.2 μm, the first width W1 of the spacer 4 is 13 μm, and the second width W2 of the main electrode 131 is 4.5 μm. Based on these parameters, plus the distance D of 5 μm, simulation is conducted to obtain transmittance levels in the cases of FIG. 4A through FIG. 4E, and the results are shown in FIG. 5. In FIG. 5, the bars 1 through 5 along the X axis represent the cases of FIG. 4A through FIG. 4E, respectively

As shown in FIG. 5, as the spacer 4 moves to the left, the transmittance decreases. For preserving a proper transmittance level, the relative relation of the main electrode 131 and the spacer 4 is the cases shown in FIG. 4A through FIG. 4D. That is, the relative relation of the main electrode 131 and the spacer 4 is in the range from where the extension line of the lateral side 131a of the main electrode 131 coincides with the end point P of the spacer 4 to where the electrode center line C1 of the main electrode 131 coincides with the spacer center line C2 of the spacer 4. In one embodiment, the relative relation is that the electrode center line C1 of the main electrode 131 coincides with the spacer center line C2 of the spacer 4, as shown in FIG. 4A.

In the above simulation, the pixel width W3 is 39.2 μm, the first width W1 of the spacer 4 is 13 μm, and the second width W2 of the main electrode 131 is 4.5 μm. However, in another embodiment of the present embodiment, the pixel width W3 is 12 μm, the first width W1 of the spacer 4 is 4 μm, and the second width W2 of the main electrode 131 is 3 μm. In further another embodiment of the present embodiment, the pixel width W3 is 40 μm, the first width W1 of the spacer 4 is 8 μm, and the second width W2 of the main electrode 131 is 4 μm

FIG. 4A through FIG. 4D show the spacer 4 moves toward the first thin film transistor unit TFT 1. However, the present disclosure is not limited thereto. The spacer 4 may alternatively more toward the second thin film transistor unit TFT2. For example, FIG. 4F shows the extension line of the opposite lateral side 131b of the main electrode 131 coincides with the opposite end point P2 of the spacer 4.

FIG. 4G is a cross-sectional view of a display device according to the line A-A′ indicated in FIG. 3. The display device of the present embodiment comprises: a first substrate 11; a second substrate 21; and a spacer 4 disposed between the first substrate 11 and the second substrate 21. The components on the first substrate 11 comprises: a scan line 121 comprising a gate electrode and disposed on the first substrate 11; a gate insulating layer 111 disposed on the scan line 121; an active layer 122 disposed on the gate insulating layer 111; a switch electrode comprising a first part 124 and a second part 125 disposed on the active layer 122; a first passivation layer 112 disposed on the first part 124 and the second part 125;

an organic layer 113 disposed on the first passivation layer 112; a second passivation layer 114 disposed on the organic layer 113; a transparent conducting electrode 13 disposed on the second passivation layer 114, wherein the transparent conducting electrode 13 electrically connects to the second part 125 through the conductive via 132 penetrating through the first passivation layer 112, the organic layer 113 and the second passivation layer 114. In addition, another electrode layer may be selectively disposed between the organic layer 113 and the second passivation layer 114; and this electrode layer can replace a storage capacitor to improve the pixel aperture ratio.

The components on the second substrate 21 comprises: a black matrix layer 23 disposed on the second substrate 21; a color filter layer 22 disposed on the black matrix layer 23; and a common electrode 24 disposed on the color filter layer 22. FIG. 4G is one possible cross sectional view of the display device, but the present disclosure is not limited thereto. In other embodiment of the present disclosure, the black matrix layer 23 and the color filter layer 22 may be disposed on the first substrate 11.

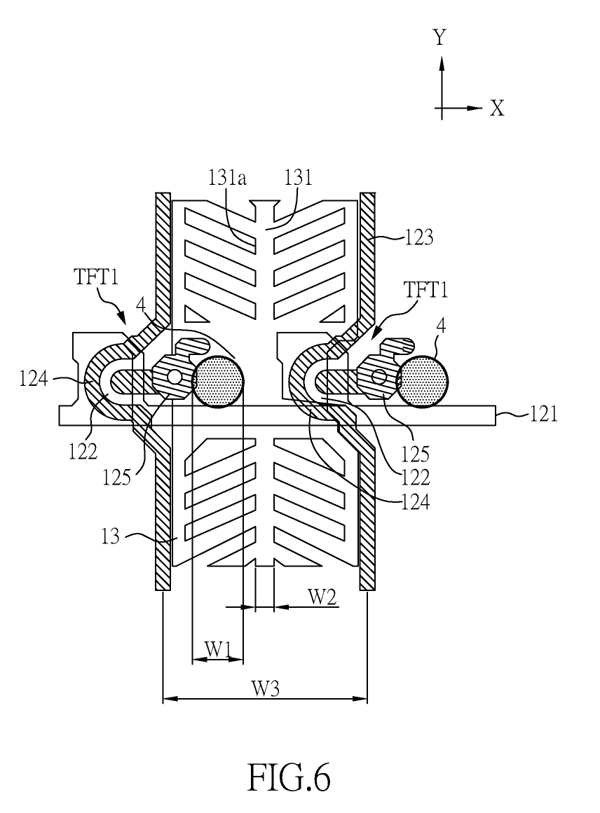

The preceding embodiments, as shown in FIG. 3 through FIG. 4F, are all about a display device with a small pixel unit. However, the present disclosure is not limited thereto. FIG. 6 is a schematic drawing of a display device of another embodiment of the present disclosure. As compared to its counterpart in FIG. 3, the pixel width W3 in FIG. 6 is greater. At this time, the spacer 4 merely partially overlaps the first thin film transistor unit TFT1, but not partially overlaps the first thin film transistor unit in the adjacent pixel unit.

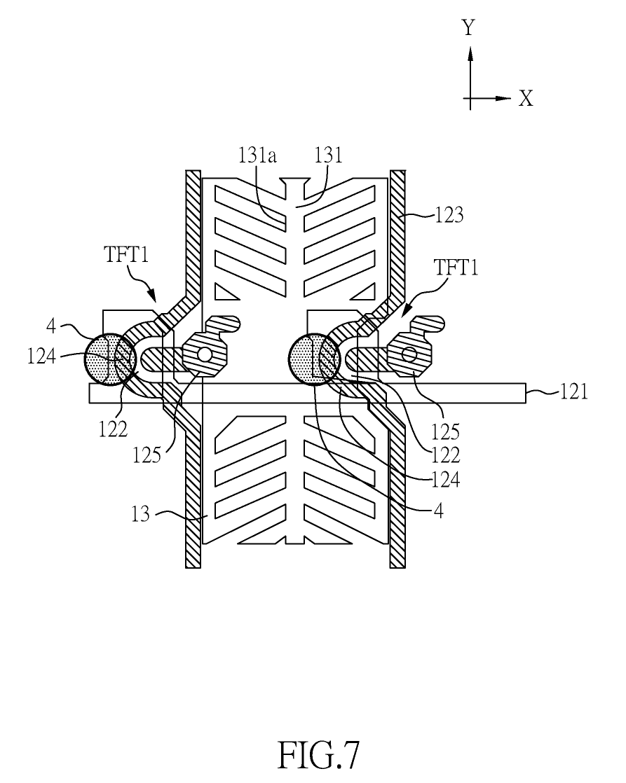

Furthermore, in the foregoing embodiment, as shown in FIG. 3 through FIG. 4F and FIG. 6, the spacer 4 is such disposed that it together with the first thin film transistor unit TFT1 and the transparent conducting electrode 13 is in the same pixel unit. However, in other embodiments of the present disclosure, the pixel unit having the first thin film transistor unit TFT1 and the transparent conducting electrode 13 and the pixel unit corresponding to the spacer 4 may be adjacent to each other, as long as the spacer 4 and the first thin film transistor unit TFT1 partially overlap each other, as shown in FIG. 7.

In the above-mentioned embodiment of the present disclosure, the spacer 4 is a round element. However, in other embodiment of the present disclosure, the spacer 4 may have a different shape, such as an elliptic shape, square shape, etc. Additionally, a backlight module (not shown) may be provided under the first substrate 11 to form a display device.

In the present disclosure, a display device made as described in any of the embodiments of the present disclosure as described previously may be integrated with a touch panel to form a touch display device. In addition, a display device or touch display device made as described in any of the embodiments of the present disclosure as described previously may be applied to any electronic devices known in the art that need a display screen, such as displays, mobile phones, laptops, video cameras, still cameras, music players, mobile navigators, TV sets, and other electronic devices that display images.

While the embodiments are provided for illustrating the concept of the present disclosure, it is to be understood that these embodiments in no way limit the scope of the present disclosure which is defined solely by the appended claims.

What is claimed is:

1. A display device, comprising:
a first substrate;
a scan line disposed on the first substrate, and extending along a first direction;
a first thin film transistor unit electrically connecting to the scan line;
a second substrate disposed opposite to the first substrate;
a display medium layer disposed between the first substrate and the second substrate;
a spacer disposed between the first substrate and the second substrate and partially overlapping the first thin film transistor unit;
a transparent conducting electrode; and
two data lines, wherein the two data lines are adjacent to each other and extending along a second direction, the first direction is different from the second direction, and the transparent conducting electrode is disposed on the scan line and between the two data lines,
wherein the transparent conducting electrode further comprises a main electrode, the main electrode has a longitudinal direction substantially identical to the second direction; wherein the spacer has a first width in the first direction, the main electrode has a second width in the first direction, and a ratio between the first width and the second width ranges between 5:1 and 5:4.

2. The display device of claim 1, wherein the first thin film transistor unit comprises a switch electrode, and the spacer partially overlaps the switch electrode.

3. The display device of claim 1, wherein the scan line passes through a central section of the transparent conducting electrode.

4. The display device of claim 3, wherein the transparent conducting electrode further comprises two slit sections and the central section locates between the two slit sections.

5. The display device of claim 3, wherein the first thin film transistor unit partially overlaps the central section.

6. The display device of claim 1, wherein two adjacent said data lines have a pixel width in the first direction, and a ratio between the first width and the pixel width is greater than 0 and smaller than 1/4.

7. The display device of claim 1, wherein, the main electrode has a lateral side and an electrode center line, the lateral side is adjacent to the first thin film transistor unit and has a longitudinal direction substantially identical to the second direction, the electrode center line extends along the second direction, the spacer has a spacer center line and an end point, the spacer center line has a longitudinal direction substantially identical to the second direction, and the end point is the point that is farthest from the first thin film transistor unit; wherein a relative relation between the main electrode and the spacer ranges from where an extension line of the lateral side of the main electrode coincides with the end point of the spacer to where the electrode center line of the main electrode coincides with the spacer center line of the spacer.

8. The display device of claim 7, wherein the electrode center line of the main electrode coincides with the spacer center line of the spacer.

9. The display device of claim 1, further comprising a second thin film transistor unit electrically connecting to the scan line and adjacent to the first thin film transistor unit, wherein the spacer partially overlaps the second thin film transistor unit.

10. The display device of claim 1, wherein the transparent conducting electrode is disposed on the scan line and between two adjacent said data lines, and the scan line locates at one side of the transparent conducting electrode.

11. The display device of claim 4, wherein the two slit sections at two sides of the central section have the same area size.

12. The display device of claim 4, wherein the two slit sections at two sides of the central section have different area size.

13. The display device of claim 7, wherein the electrode center line of the main electrode does not coincide with the spacer center line of the spacer.

14. The display device of claim 1, wherein the spacer is in the shape of an inverted trapezoid.

15. The display device of claim 1, wherein the spacer is in the shape of a regular trapezoid.

16. The display device of claim 1, wherein the first thin film transistor unit and the transparent conducting electrode are disposed in one pixel unit, and the spacer is disposed in another pixel unit adjacent to the one pixel unit.
